(19) United States
(12) Patent Application Publication
(10) Pub. No.: US 2015/0195502 A1
(43) Pub. Date: Jul. 9, 2015

(54) DISPLAY DEVICE AND CONTROLLING METHOD THEREOF

(71) Applicant: INNOLUX CORPORATION, Chu-Nan (TW)

(72) Inventor: Naoki SUMI, Chu-Nan (TW)

(73) Assignee: INNOLUX CORPORATION, Chu-Nan (TW)

(21) Appl. No.: 14/148,113

(22) Filed: Jan. 6, 2014

(51) Int. Cl. H04N 13/00; H04N 13/04

(52) U.S. Cl. CPC H04N 13/004; H04N 13/0051; H04N 13/0402; H04N 13/0452; H04N 13/0468

(57) ABSTRACT

A controlling method of a 2D/3D switchable display device is provided. The display device includes an optical modulating panel with an optical modulating layer and a display panel with a pixel layer. Firstly, a viewing position is sensed, and a viewing distance and a viewing angle with respect to the viewing position are obtained accordingly. Then, a distance mode is judged according to the viewing distance. A current data set is further selected according to the distance mode and the viewing angle. The pixel layer displays the current data set which is partially filtered by the optical filter layer.

### FIELD OF THE INVENTION

The present invention relates to a display device and a controlling method thereof, and more particularly to a 2D/3D switchable display device and a controlling method thereof.

### BACKGROUND OF THE INVENTION

When images with parallax and seen by the two eyes of the viewer, a stereoscopic image is generated. There are two types of auto-stereoscopic display: barrier type and lenticular type. For the conventional 3D display device, data set of the pixel layer changes when viewing position of the viewer is moved horizontally. The sub-pixels contained in a data set (taking two pixels for instance, and each of the pixels is with three sub pixels) can be selected form one of LLRRRL, LRRRLL, RRRLLL, RRLLLR, RLLLRR, or LLLRRR. However, it just keep 3D image quality in horizontally shifting.

Therefore, when viewing distance is changed, the viewer can barely see clear 3D images on the conventional 3D display device. In other words, viewing zones of the conventional 3D display device are very limited. Such limitation of viewing positions causes inconveniences when people watch the 3D display device.

### SUMMARY OF THE INVENTION

An embodiment of the present invention provides a controlling method of a 2D/3D switchable display device, the display device comprising a display panel with a pixel layer, the controlling method comprising steps of: sensing a viewing position and accordingly obtaining a viewing distance and a viewing angle; judging a distance mode according to the viewing distance; and, adjusting data set of the pixel layer according to the distance mode and the viewing angle.

Another embodiment of the present invention provides a display device, comprising: a sensor, for sensing a viewing position; a position converter, electrically connected to the sensor, for obtaining a viewing distance and a viewing angle according to the viewing position; a selector, electrically connected to the position converter, for judging a distance mode according to the viewing distance; and, a display panel, electrically connected to the selector, comprising: a pixel layer, for displaying a data set, wherein the data set of the pixel layer is adjusted according to the distance mode and the viewing angle.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram illustrating different viewing positions of watching 3D display device;

FIG. 2 is a table illustrating data sets corresponding to the 3D far distance mode and the 3D near distance mode;

FIGS. 3A, 3B, 3C, 3D and 3E are schematic side views illustrating the data set of the pixel layer of the 3D display panel when the viewing distance is judged as the 3D far distance mode;

FIG. 4 is a schematic view illustrating viewing zones corresponding to the 3D far distance mode in which good quality 3D images are displayed;

FIGS. 5A, 5B, 5C, 5D and 5E are schematic side views illustrating the data set of the pixel layer of the 3D display panel when the viewing distance is judged as the 3D near distance mode;

FIG. 6 is a schematic view illustrating viewing zones corresponding to the 3D near distance mode in which good quality 3D images are displayed;

FIG. 7A is a schematic view illustrating constitutions of the pixels seen by left and right eyes of the view in a far distance case;

FIG. 7B is a schematic view illustrating constitutions of the pixels seen by left and right eyes of the viewer in a near distance case;

FIG. 8 is a table illustrating constitutions of the pixels seen by the left and right eyes of the viewer in the 3D far distance mode and the 3D near distance mode;

FIG. 9A is a schematic view of allocations of the sub-pixels of the display device;

FIG. 9B is a schematic view of adjusting the data set of the pixel layer to display the first data set of 3D near distance mode C_c1;

FIG. 10 is a schematic view of the sub-pixels R, G, and B in FIG. 13A displaying the data set LCRRL in FIG. 13B;

FIG. 11A is a schematic view of a viewing position to a display device;

FIG. 11B is a schematic view of obtaining viewing angle according to the viewing position;

FIG. 12 is a schematic functional block diagram illustrating a 3D view control unit of the first embodiment according to the present invention;

FIG. 13 is a flowchart illustrating a method of controlling the display panel according to an embodiment of the present invention;

FIG. 14 is a schematic diagram illustrating a data table with various data sets are provided according to the viewing distance and the viewing angle;

FIG. 15 is a schematic diagram illustrating a data table with various data sets, wherein each of the data sets constitutes six sub-pixels;

FIG. 16 is a schematic view illustrating formulation of 3D image based on multi-view technology;

FIG. 17 is a schematic view illustrating more data sets are provided according to another embodiment of the present invention;

FIG. 18 is a schematic functional block diagram illustrating a 3D view control block of an embodiment with multiple center view data; and,

FIG. 19 is a schematic diagram illustrating the application of the present invention to a display device with large screen size.

### DETAILED DESCRIPTION OF PREFERRED EMBODIMENTS

The present invention provides a display device and a controlling method thereof. The display device with 2D/3D switchable ability comprises a display panel, an optical modulating panel, and a control unit. The display panel comprises a display layer with a plurality of pixels (sub pixels), and the optical modulating panel comprises an optical modulating layer with a plurality of pixels for controlling light phenomenon. The control unit is electrically connected with the display panel and the optical modulating panel. And, the parallax barrier panel is between the view and the display panel. For meeting the user's requirements, the viewing position of the user is firstly sensed and referred for controlling the display device. In accordance with the present invention, an eye position may be acquired by an eye-tracking technology. It is noted that the viewing position is not restricted to the eye position. For example, the viewing position may indicate the head position, the eye position, the midpoint between the two eyes or the midpoint between the two eyebrows etc. Besides, the viewing position can be sensed by a normal camera or an IR camera etc.

According to the present invention, a viewing distance is defined as distance between center of the display device and the viewing position. The display device firstly retrieves the viewing position by eye-tracking technology, and obtains the viewing distance according to the viewing position. A distance mode corresponding to the viewing position is then judged. In an embodiment, the distance mode may be a 3D far distance mode or a 3D near distance mode. After the distance mode is judged, the display device dynamically adjusts data set of pixel layer according to the viewing angle. Consequently, the display panel according to the embodiment of the present invention allows the viewer to watch 3D images in a more flexible manner.

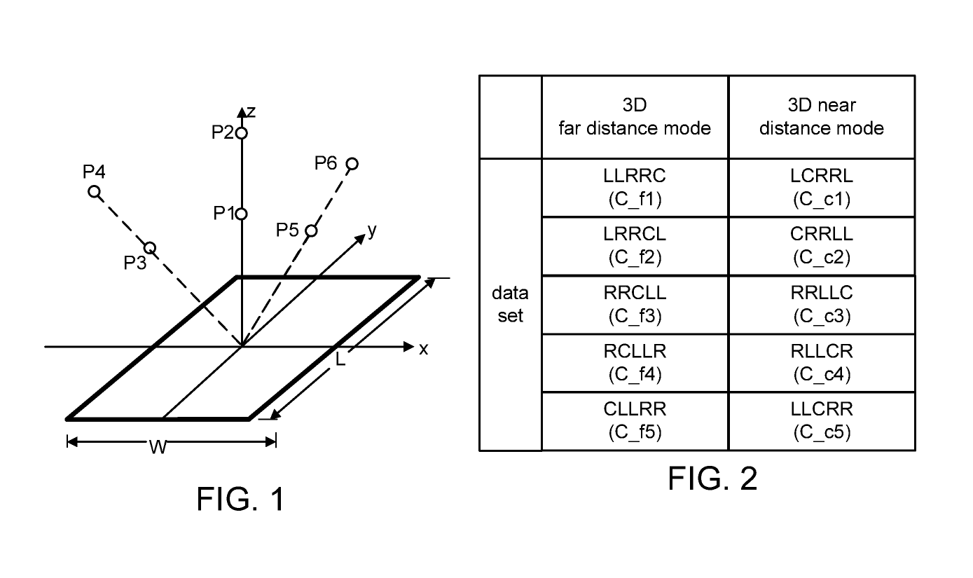

FIG. 1 is a schematic diagram illustrating different viewing positions of watching 3D display device. The viewing distances of the first viewing position P1, the third viewing position P3, and the fifth viewing position P5 are judged as a 3D near distance mode. Afterwards, the display device further selects a suitable data set from plural data sets corresponding to the 3D near distance mode according to viewing angles of the first viewing position P1, the third viewing position P3, and the fifth viewing position P5.

Furthermore, the viewing distances of the second viewing position P2, the fourth viewing position P4, and the sixth viewing position P6 are judged as a 3D far distance mode. Afterwards, the display device further selects a suitable data set from plural data sets corresponding to the 3D far distance mode according to viewing angles of the second viewing position P2, the fourth viewing position P4, and the sixth viewing position P6.

FIG. 2 is a table illustrating data sets corresponding to the 3D far distance mode and the 3D near distance mode. When the viewing distance is judged as the 3D far distance mode, the data set of the display device may be one of the first data set of 3D far distance mode LLRRC(C_f1), the second data set of 3D far distance mode LRRCL(C_f2), the third data set of 3D far distance mode RRCLL(C_f3), the fourth data set of 3D far distance mode RCLLR(C_f4), and the fifth data set of 3D far distance mode CLLRR(C_f5). When the viewing distance is judged as the 3D near distance mode, the data of the display device may be one of the first data set of 3D near distance mode LCRRL(C_c1), the second data set of 3D near distance mode CRRLL(C_c2), the third data set of 3D near distance mode RRLLC(C_c3), the fourth data set of 3D near distance mode RLLCR(C_c4), and the fifth data set of 3D near distance mode LLCRR(C_c5).

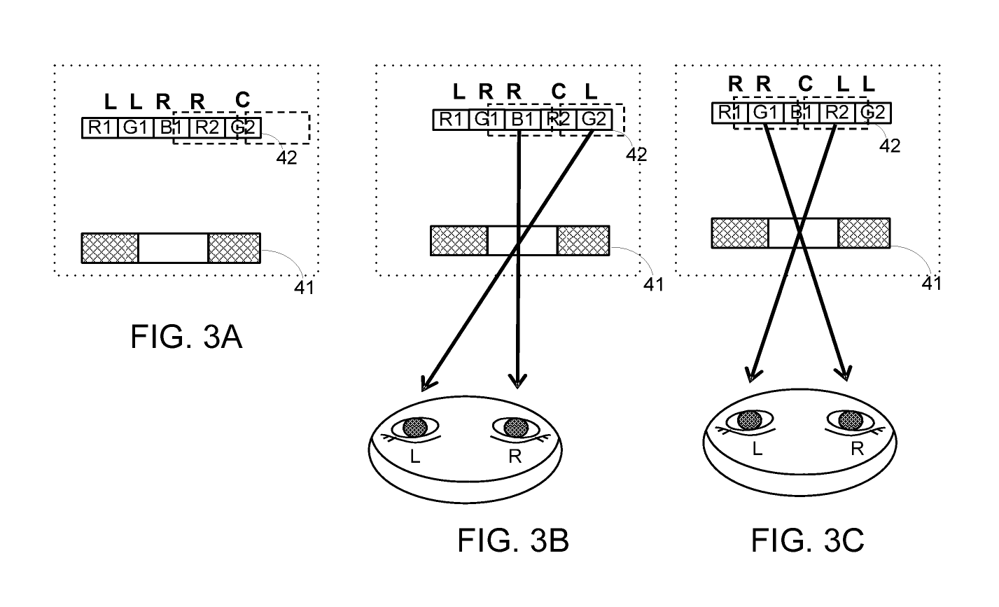

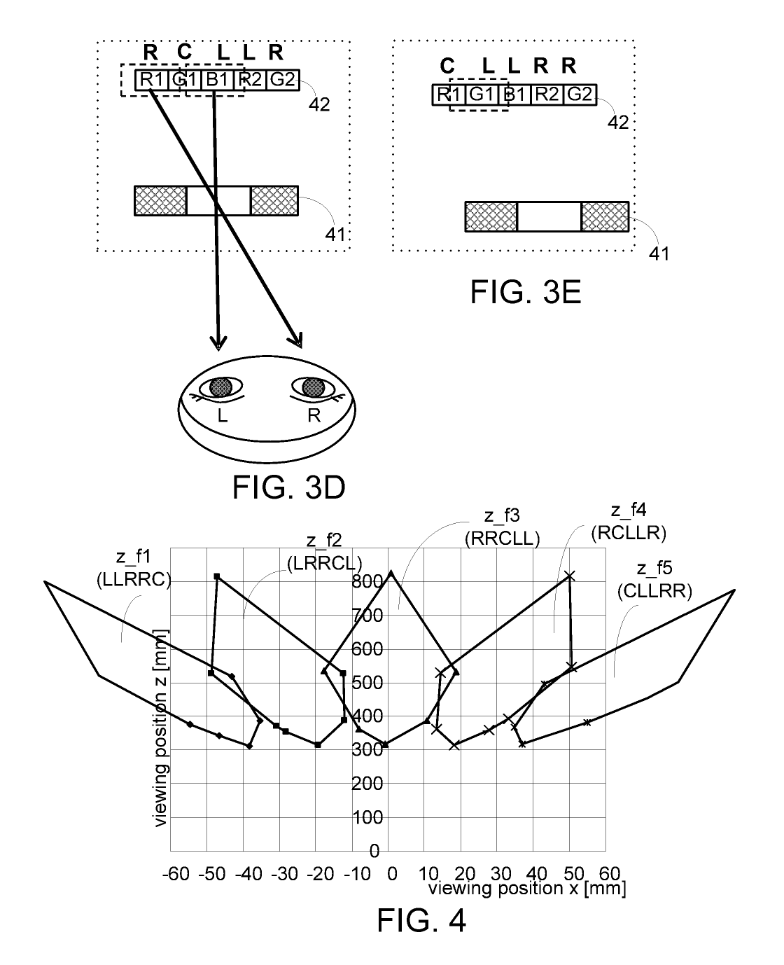

FIGS. 3A, 3B, 3C, 3D and 3E are schematic side views illustrating the data set of the pixel layer of the 3D display panel when the viewing distance is judged as the 3D far distance mode. As shown in FIGS. 3A, 3B, 3C, 3D and 3E, the first row of blocks are sub-pixels in the pixel layer 42 of the display panel, the second row of blocks are opaque portion and transparent portion of the optical modulating layer 41, and the viewing position of the viewer is under the optical modulating layer 41. In the embodiment, the optical modulating layer 41 is barrier type.

In FIGS. 3A, 3B, 3C, 3D and 3E, the red sub-pixel of the first pixel R1, the green sub-pixel of the first pixel G1, the blue sub-pixel of the first pixel B1, the red sub-pixel of the second pixel R2, the green sub-pixel of the second pixel G2 and the blue sub-pixel of the second pixel B2 are sequentially shown (from left to right). Although positions of these sub-pixels are fixed, data contents displayed by these sub-pixels vary. In these drawings, R, L and C are used for indicating data contents displayed by the sub-pixels. The right view data are indicated as R, and the left view data are indicated as L. Furthermore, a center view data is indicated as C. The center view data may be generated by referring to the left view data L and the right view data R. For instance, the center view data may be obtained by calculating an intermediate parallax view data based on a depth analysis from the left view data L and right view data R.

In FIG. 3A, data set of the pixel layer 42 is the first data set of 3D far distance mode C_f1 (i.e. data set LLRRC). In such case, the right eye of the viewer will see the blue sub-pixel of the first pixel B1 displaying right view data R, the red sub-pixel of the second pixel R2 displaying right view data R, and the green sub-pixel of the second pixel G2 displaying center view data C.

In FIG. 3B, data set of the pixel layer 42 is the second data set of 3D far distance mode C_f2 (i.e. data set LRRCL). In such case, the right eye of the viewer will see the green sub-pixel of the first pixel G1 displaying right view data R, the blue sub-pixel of the first pixel B1 displaying right view data R, and the red sub-pixel of the second pixel R2 displaying center view data C.

According to FIGS. 3A and 3B, in the 3D far distance mode, the display device actively detects change of the viewing position and automatically adjusts which of the view data should be displayed by the sub-pixels. Meanwhile, the sub-pixels seen by the right eye of the viewer remains to display the right view data R, the right view data R, and the center view data C (i.e. view data are displayed in the order of RRC).

In FIG. 3C, data set of the pixel layer 42 is the third data set of 3D far distance mode C_f3 (i.e. data set RRCLL). In such case, the right eye of the viewer will see the red sub-pixel of the first pixel R1 displaying right view data R, the green sub-pixel of the first pixel G1 displaying right view data R, and the blue sub-pixel of the first pixel B1 displaying center view data C. Furthermore, the left eye of the viewer will see the blue sub-pixel of the first pixel B1 displaying center view data C, the red sub-pixel of the second pixel R2 displaying left view data L, and the green sub-pixel of the second pixel G2 displaying left view data L.

In FIG. 3D, data set of the pixel layer 42 is the fourth data set of 3D far distance mode C_f4 (i.e. data set RCLLR). In such case, the left eye of the viewer will see the green sub-pixel of the first pixel G1 displaying center view data C, the blue sub-pixel of the first pixel B1 displaying left view data L, and the red sub-pixel of the second pixel R2 displaying left view data L.

In FIG. 3E, data set of the pixel layer 42 is the fifth data set of 3D far distance mode C_f5 (i.e. data set CLLRR). In such case, the left eye of the viewer will see the red sub-pixel of the first pixel R1 displaying center view data C, the green sub-pixel of the first pixel G1 displaying left view data L, and the blue sub-pixel of the second pixel B1 displaying left view data L.

According to FIGS. 3C, 3D and 3E, in the 3D far distance mode, the display device actively detects change of viewing position and automatically adjusts which of the view data should be displayed by the sub-pixels. Meanwhile, the sub-pixels seen by the left eye of the viewer remains to display the center view data C, the left view data L, and the left view data L (i.e. view data are displayed in the order of CLL).

Based on the above illustrations, a pixel seen by the left eye of the viewer is composed of a sub-pixel displaying center view data C and two sub-pixels displaying left view data L; and a pixel seen by the right eye of the viewer is composed of a sub-pixel displaying center view data C and two sub-pixels displaying right view data R. Furthermore, the sub-pixel displaying the center view data C is simultaneously seen by both the left eye and the right eye of the viewer.

FIG. 4 is a schematic view illustrating viewing zones corresponding to the 3D far distance mode in which good quality 3D images are displayed. The horizontal axis represents x coordinate of the viewing position, and the vertical axis represents z coordinate of the viewing position. According to FIG. 4, data set of the pixel layer changes when the viewing position is judged as the 3D far distance mode and moves in the x-axis direction.

When the viewing position is corresponding to the first viewing zone of 3D far distance mode z_f1, the data set of the pixel layer 42 is the first data set of 3D far distance mode C_f1 (see FIG. 3A, data set LLRRC). When the viewing position is corresponding to the second viewing zone of 3D far distance mode z_f2, the data set of the pixel layer 42 is the second data set of 3D far distance mode C_f2 (see FIG. 3B, data set LRRCL). When the viewing position is corresponding to the third viewing zone of 3D far distance mode z_f3, the data set of the pixel layer 42 is the third data set of 3D far distance mode C_f3 (see FIG. 3C, data set RRCLL). When the viewing position is corresponding to the fourth viewing zone of 3D far distance mode z_f4, the data set of the pixel layer 42 is the fourth data set of 3D far distance mode C_f4 (see FIG. 3D, data set RCLLR). When the viewing position is corresponding to the fifth viewing zone of 3D far distance mode z_f5, the data set of the pixel layer 42 is the fifth data set of 3D far distance mode C_f5 (see FIG. 3E, data set CLLRR).

According to FIG. 4, the display device according to the first embodiment of the present invention provides appropriate 3D images when the z coordinate of the viewing position is between 350 mm to 750 mm. Furthermore, when the z coordinate of the viewing position is between 350 mm to 750 mm, and the x coordinate of the viewing position changes, the display device according to the present embodiment can still display 3D images appropriately.

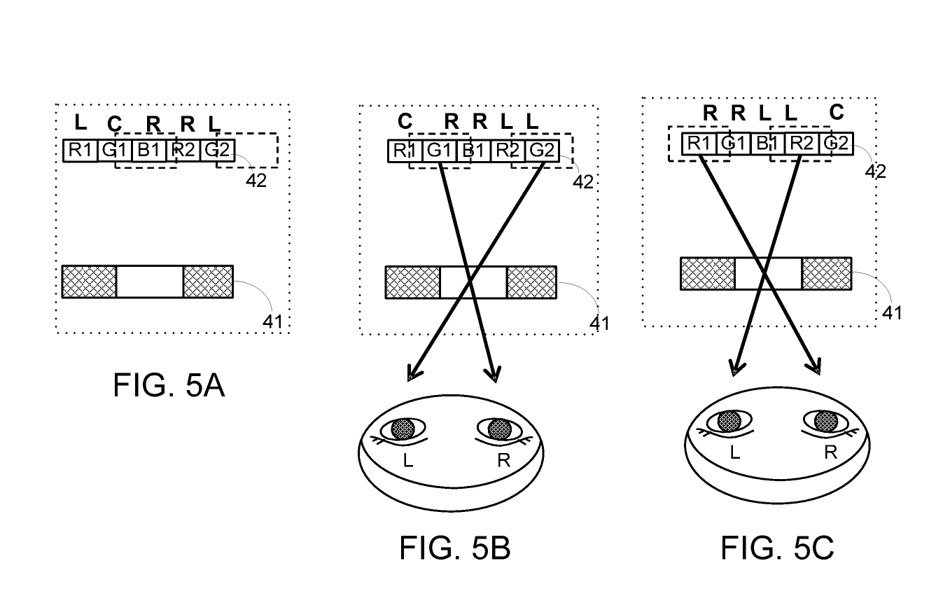

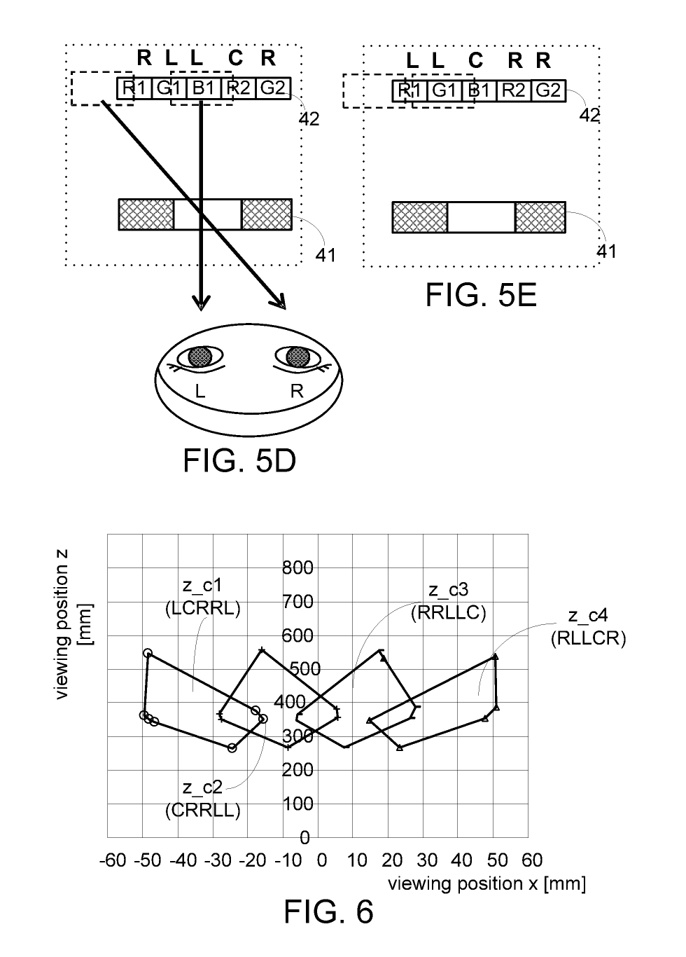

FIGS. 5A, 5B, 5C, 5D and 5E are schematic side views illustrating the data set of the pixel layer of the 3D display panel when the viewing distance is judged as the 3D near distance mode. As shown in FIGS. 5A, 5B, 5C, 5D and 5E, the first row of blocks are sub-pixels in the pixel layer 42, the second row of blocks are opaque portion and transparent portion of the optical modulating layer 41, and the viewing position of the viewer is under the optical modulating layer.

In FIGS. 5A, 5B, 5C, 5D and 5E, the red sub-pixel of the first pixel R1, the green sub-pixel of the first pixel G1, the blue sub-pixel of the first pixel B1, the red sub-pixel of the second pixel R2, the green sub-pixel of the second pixel G2 and the blue sub-pixel of the second pixel B2 are sequentially shown (from left to right). Although positions of these sub-pixels are fixed, data contents displayed by these sub-pixels vary. In these drawings, R, L and C are used for indicating data contents displayed by the sub-pixels. The right view data are indicated as R, and the left view data are indicated as L. Furthermore, a center view data is indicated as C. The center view data may be generated by referring to the left view data L and the right view data R. For instance, the center view data may be obtained by calculating an intermediate parallax view data based on a depth analysis from the left view data L and right view data R.

In FIG. 5A, data set of the pixel layer is the first data set of 3D near distance mode C_c1 (i.e. data set LCRRL). In such case, the right eye of the viewer will see the green sub-pixel of the first pixel G1 displaying center view data C, the blue sub-pixel of the first pixel B1 displaying right view data R, and the red sub-pixel of the second pixel R2 displaying right view data R.

In FIG. 5B, data set of the pixel layer is the second data set of 3D near distance mode C_c2 (i.e. data set CRRLL). In such case, the right eye of the viewer will see the red sub-pixel of the first pixel R1 displaying center view data C, the green sub-pixel of the first pixel G1 displaying right view data R, and the blue sub-pixel of the first pixel B1 displaying right view data R.

According to FIGS. 5A and 5B, in the 3D near distance mode, the display device actively detects change of viewing position and automatically adjusts which of the view data should be displayed by the sub-pixels. Meanwhile, the sub-pixels seen by the right eye of the viewer remains to display the center view data C, the right view data R, and the right view data R (i.e. view data are displayed in the order of CRR).

In FIG. 5C, data set of the pixel layer 42 is the third data set of 3D near distance mode C_c3 (i.e. data set RRLLC). In such case, the left eye of the viewer will see the blue sub-pixel of the first pixel B1 displaying left view data L, the red sub-pixel of the second pixel R2 displaying left view data L, and the green sub-pixel of the second pixel G2 displaying center view data C.

In FIG. 5D, data set of the pixel layer 42 is the fourth data set of 3D near distance mode C_c4 (i.e. data set RLLCR). In such case, the left eye of the viewer will see the green sub-pixel of the first pixel G1 displaying left view data L, the blue sub-pixel of the first pixel B1 displaying left view data L, and the red sub-pixel of the second pixel R2 displaying center view data C.

In FIG. 5E, data set of the pixel layer 42 is the fifth data set of 3D near distance mode C_c5 (i.e. data set LLCRR). In such case, the left eye of the viewer will see the red sub-pixel of the first pixel R1 displaying left view data L, the green sub-pixel of the first pixel G1 displaying left view data L, and the blue sub-pixel of the first pixel B1 displaying center view data C.

According to FIGS. 5C, 5D and 5E, in the 3D near distance mode, the display device actively detects change of viewing position and automatically adjusts which of the view data should be displayed by the sub-pixels. Meanwhile, the sub-pixels seen by the left eye of the viewer remains to display the left view data L, the left view data L, and the center view data C (i.e. view data are displayed in the order of LLC).

Based on the above illustrations, a pixel seen by the left eye of the viewer is composed of a sub-pixel displaying center view data C and two sub-pixels displaying left view data L; and a pixel seen by the right eye of the viewer is composed of a sub-pixel displaying center view data C and two sub-pixels displaying right view data R. Furthermore, the sub-pixel displaying the center view data C seen by the left eye of the viewer is different from the one seen by the right eye of the viewer.

FIG. 6 is a schematic view illustrating viewing zones corresponding to the 3D near distance mode in which good quality 3D images are displayed. The horizontal axis represents x coordinate of the viewing position, and the vertical axis represents z coordinate of the viewing position. According to FIG. 10, data set of the pixel layer changes when the viewing position is judged as the 3D near distance mode and moves in the x-axis direction.

When the viewing position is corresponding to the first viewing zone of 3D near distance mode z_c1, the data set of the pixel layer 42 is the first data set of 3D near distance mode C_c1 (see FIG. 5A, data set LCRRL). When the viewing position is corresponding to the second viewing zone of 3D near distance mode z_c2, the data set of the pixel layer 42 is the second data set of 3D near distance mode C_c2 (see FIG. 5B, data set CRRLL). When the viewing position is corresponding to the third viewing zone of 3D near distance mode z_c3, the data set of the pixel layer 42 is the third data set of 3D near distance mode C_c3 (see FIG. 5C, data set RRLLC). When the viewing position is corresponding to the fourth viewing zone of 3D near distance mode z_c4, the data set of the pixel layer 42 is the fourth data set of 3D near distance mode C_c4 (see FIG. 5D, data set RLLCR).

According to FIG. 6, the display device according to the first embodiment of the present invention provides appropriate 3D images when the z coordinate of the viewing position is between 280 mm to 550 mm. Furthermore, when the z coordinate of the viewing position is between 280 mm to 550 mm, and the x coordinate of the viewing position changes, the display device according to the present embodiment can still display 3D images appropriately.

Based on the above illustrations, both the right view data R and the center view data C are simultaneously seen by the right eye of the viewer. Both the left view data L and the center view data C are simultaneously seen by the left eye of the viewer. When the viewing distance is relatively far from an object, an included angle formed by view lines of the two eyes of the viewer is smaller. Thus, when the viewing distance is relatively far from the object, less sub-pixels can be seen. The included angle between the view lines of two eyes determine range and/or number of the sub-pixels seen by the view. Consequently, the center view data C is inserted in different manner.

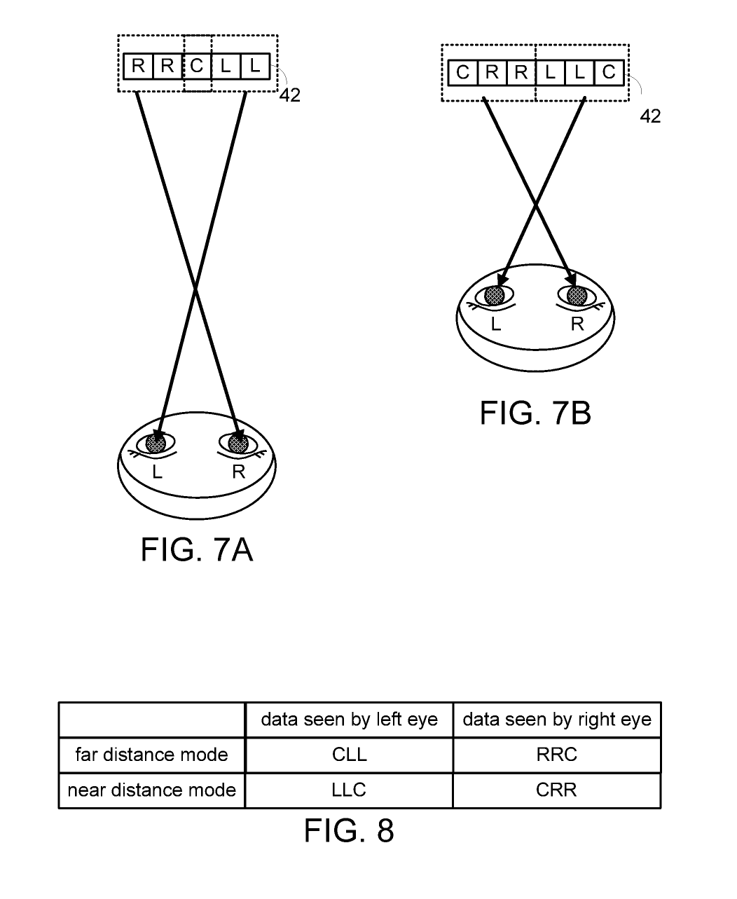

FIG. 7A is a schematic view illustrating constitutions of the pixels seen by left and right eyes of the view in a far distance case. In such case, the center view data C seen by both the right eye and the left eye of the viewer are identical. The sub-pixels seen by the right eye of the viewer display view data in the sequence of RRC. The sub-pixels seen by the left eye of the viewer display view data in the sequence of CLL. In the 3D far distance mode, the center view data C is likely to be inserted inside the right view data R and the left view data L, and such situation is called internal insertion of the center view data C.

FIG. 7B is a schematic view illustrating constitutions of the pixels seen by left and right eyes of the viewer in a near distance case. In such case, the center view data C seen by both the right eye and the left eye of the viewer are separate. The sub-pixels seen by the right eye of the viewer display view data in the sequence of CRR. The sub-pixels seen by the left eye of the viewer display view data in the sequence of LLC. In the 3D near distance mode, the center view data C is likely to be placed at two opposite sides of the right view data R and the left view data I, and such situation is called external insertion of the center view data C.

FIG. 8 is a table illustrating constitutions of the pixels seen by the left and right eyes of the viewer according to the above embodiment. In the 3D far distance mode and the 3D near distance mode, the constitutions of the pixels seen by the viewer are different.

In the 3D far distance mode, the sub-pixels seen by the left eye of the viewer always constitute view data in the sequence of CLL, and the sub-pixels seen by the right eye of the viewer always constitute view data in the sequence of RRC, regardless changes of the viewing angle. In the 3D near distance mode, the sub-pixels seen by the left eye of the viewer always constitute view data in the sequence of LLC, and the sub-pixel seen by the right eye of the viewer always constitute view data in the sequence of CRR, regardless changes of the viewing angle.

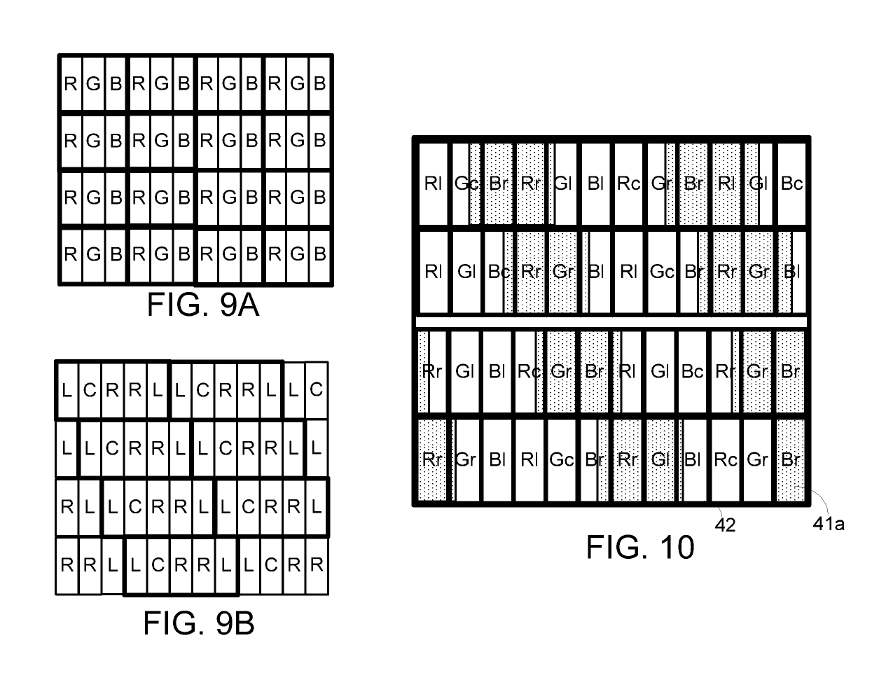

FIG. 9A is a schematic view of allocations of the sub-pixels of the display panel. As shown in FIG. 9A, each pixel includes a red sub-pixel R, a green sub-pixel G, and a blue sub-pixel B. The allocations the sub-pixels in each row of pixels are consistent. Accompanied with change of viewing position, the view data displayed by the sub-pixels in the pixel layer will be adjusted. Details about how to adjust data set displayed by the sub-pixels in the pixel layer are discussed below.

FIG. 9B is a schematic view of adjusting the data set of the pixel layer to display the first data set of 3D near distance mode C_c1. When the data set of the pixel layer is selected, the sub-pixels of the pixel layer will sequentially display the sequence of view data corresponding to the selected data set. Therefore, in FIG. 9B, sub-pixels in each row cyclically and sequentially display the view data in the sequence of LCRRL. The arrangement of sub-pixels displaying sequence of data set LCRRL is not aligned. Instead, the first sub-pixel in each row to display the sequence of data set LCRRL data set will shift by one. The shift of the data set is to avoid the problem of generating undersigned colored image from non-uniform brightness of RGB color of the display panel.

FIG. 10 is a schematic view of the sub-pixels R, G, and B in FIG. 9A displaying the data set LCRRL in FIG. 9B. FIG. 10 is with similar arrangement of the FIGS. 9A and 9B. As shown in FIG. 10, each pixel includes three sub-pixels R, G, and B, where in “r” indicates the right view data, “I” indicates the left view data, and “c” indicates the center view data. Thus, the sub-pixels in the first row (from left to right) are: the red sub-pixel displaying the left view data (RI), the green sub-pixel displaying the center view data (Gc), the blue sub-pixel displaying the right view data (Br), and the red sub-pixel displaying the right view data (Rr) etc.

The parallax barrier layer 41 is composed of the opaque portion and the transparent portion. Due to the shift of the data set LCRRL shown in FIG. 9B, the opaque layer in FIG. 10 is not completely arranged along the vertical direction. Accordingly, the sub-pixels under the opaque portion are not completely aligned with each other and are possibly shifted.

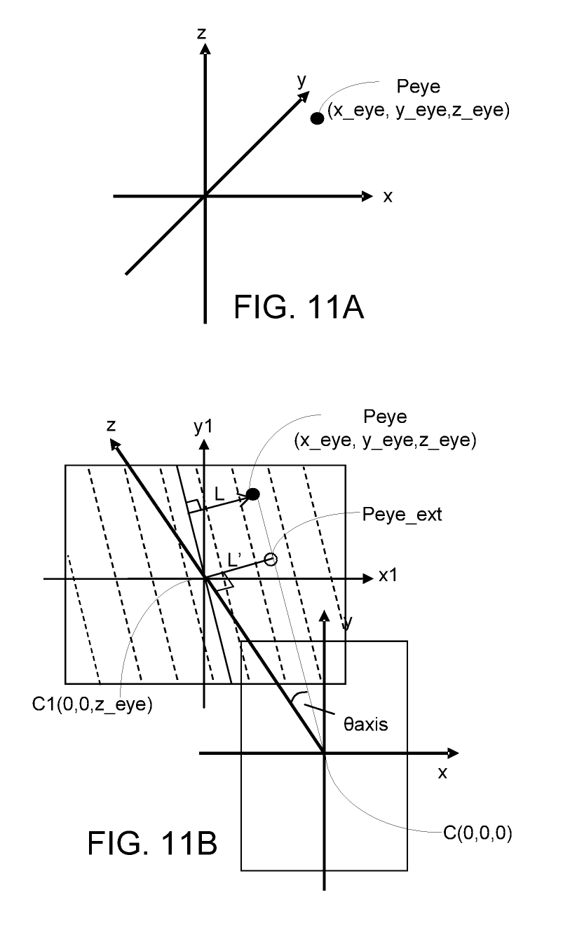

FIG. 11A is a schematic view of a viewing position to a display device. The coordinate of the viewing position is assumed to be (x, y, z)=(x_eye, y_eye, z_eye). According to the coordinate, the viewing distance D can be obtained.

D=\sqrt{x_{eye}²+y_{eye}²+z_{eye}²}

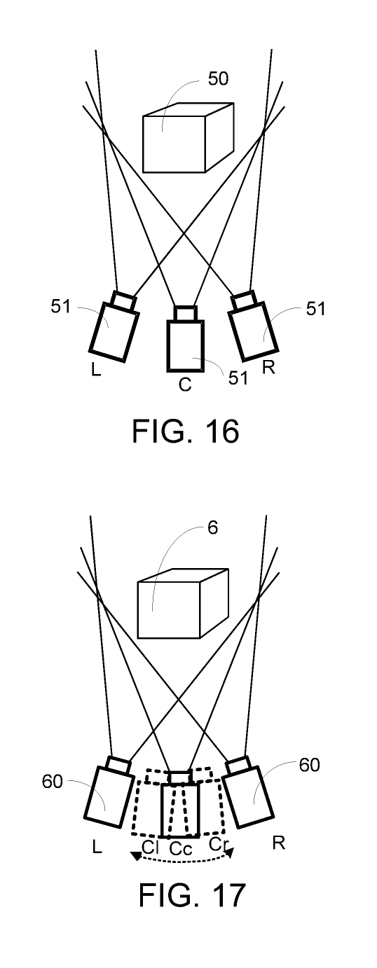

FIG. 11B is a schematic view of obtaining viewing angle according to the viewing position. The horizontal plane where the viewing position located is defined as x1-y1 plane (i.e. the x1-y1 plane is the horizontal plane at z=z_eye). The coordinate of the center of the x1-y1 planes is (x, y, z)=(0, 0, z_eye). The oblique lines on the x1-y1 plane indicate the arrangement of the opaque layer. As mentioned above, the opaque layer is not parallel to the vertical direction (i.e. direction parallel to y axis) to avoid coloring issue. The linear equation of the oblique lines in FIG. 16B is assumed to be 3x+y=0.

A segment L is drawn, wherein the segment L starts from the viewing position and is perpendicular to one of the oblique lines. The offset of the segment L passing the center of the x1-y1 plane is L′. One end of the segment L′ is the center of the x1-y1 plane and the other end is an offset of the viewing position Peye_ext. Consequently, a perpendicular triangle is formed by the offset of the viewing position Peye_ext, center of the x1-y1 plane, and the center of the x-y plane. With the perpendicular triangle, the viewing angle θaxis can be obtained.

$${θ}_{axis} = {tan}^{- 1} ( \frac{{y}_{eye} + 3 {x}_{eye}}{{z}_{eye} \sqrt{10}} )$$

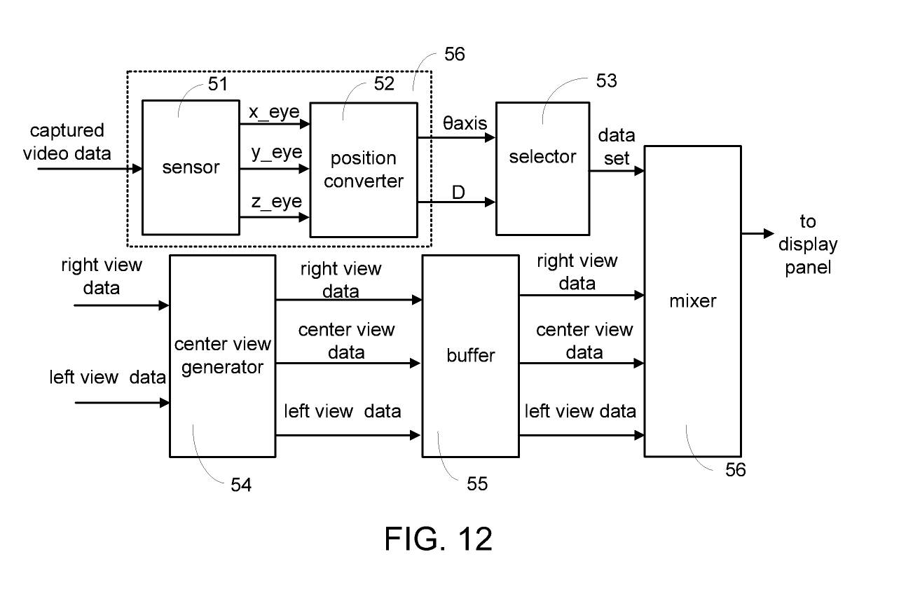

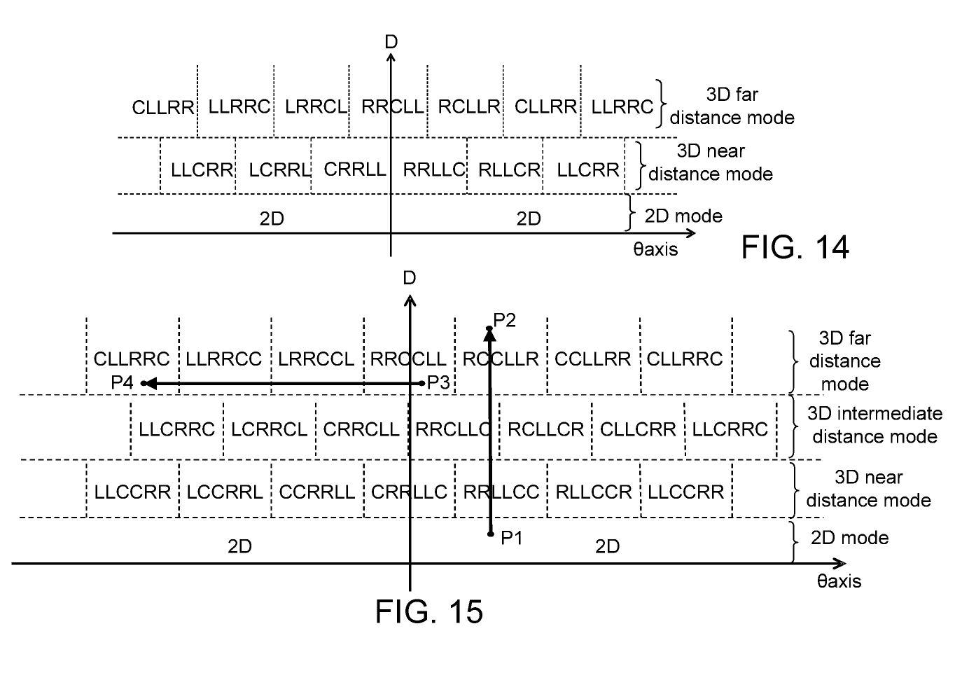

FIG. 12 is a schematic functional block diagram illustrating a 3D view control unit of the first embodiment according to the present invention. An upper transmission path and a lower transmission path are shown in FIG. 15. The upper transmission path indicates selection of the data set, and the lower transmission path indicates generation of the center view data.

As shown in FIG. 12, the 3D view control unit includes a sensing unit 56, a selector 53, a center view generator 54, a buffer 55, and a mixer 56. The sensing unit 56 comprises a sensor 51 and a position converter 52. The operation of the upper transmission path is firstly illustrated. After receiving captured video data, the sensor 51 of the sensing unit 56 senses the viewing position parameters on the coordinates (x_eye, y_eye, z_eye) and transmits the viewing position to the position converter 52 of the sensing unit 56. Then, the position converter 52 calculates and obtains the viewing distance D and the viewing angle θaxis. According to the viewing distance D and the viewing angle θaxis, the selector 53 may select one of the data sets (data arrangement) of the data table and outputted to the pixel layer of the display panel. The selection of which data set should be adopted is further transmitted to the mixer 56.

The operation of the lower transmission path is illustrated below. The center view generator 54 receives the right view data R and the left view data L and accordingly generates the center view data C. The right view data R, the center view data C and the left view data L are temporarily stored in the buffer 55 and further provided to the mixer 56. Moreover, the mixer 56 mixes the right view data R, the center view data C, the left view data L and the data set (data arrangement) outputted from the selector 53. The mixture result outputted from the mixer 56 to be displayed by the pixel layer of the display panel. For instance, if the selector 53 selects the first near distance data set C_c1, the mixer 56 will correspondingly output data set in the sequence of LCRRL to the display panel.

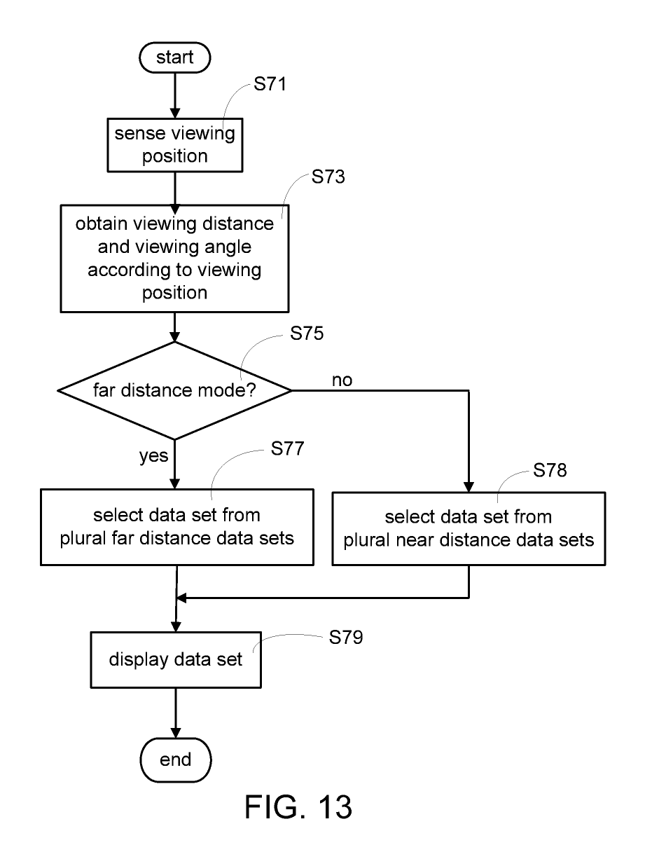

FIG. 13 is a flowchart illustrating a method of controlling the display panel according to an embodiment of the present invention. Firstly, the viewing position is sensed (step S71). The position converter calculates and obtains the viewing distance and the viewing angle according to the viewing position (step S73). Then step S75 is performed to judge a distance mode of the viewing position. The judgment may made by comparing the viewing distance with a far distance threshold. If the judging condition of the step S75 is satisfied, the selector judges the viewing position is belong to the 3D far distance mode and selects data set of the pixel layer from plural 3D distance mode data sets (step S77). Whereas, if the judging condition of the step S75 is not satisfied, the selector judges the viewing position is belong to the 3D near distance mode and selects data set of the pixel layer from plural 3D near mode data sets. Then, the pixel layer displays the selected data set (step S79).

FIG. 14 is a schematic diagram illustrating a data table with various data sets are provided according to the viewing distance and the viewing angle. When the viewing distance is very short, the crosstalk between the left view data L and the right view data R is serous so that 3D images cannot be properly displayed. Therefore, when the viewing distance is less than a near distance threshold, the display device displays 2D images. When the viewing distance is equivalent to or greater than the near distance threshold, the display device display 3D images.

When the viewing distance is between the near distance threshold and the far distance threshold, five different data sets of 3D near distance mode (LLCRR, LCRRL, CRRLL, RRLLC, RLLCR) are provided. The 3D near distance mode also called external C insertion; C is the center view data. The external C insertion means the center view data C is sequentially inserted behind series right view data R pairs and left view data L pairs (RRLLC). According to changes of the viewing angle, one of the five data sets of 3D near distance mode (LLCRR, LCRRL, CRRLL, RRLLC, RLLCR) is selected and displayed by the pixel layer. The 3D far distance mode also called internal C insertion, C is the center view data. The internal C insertion means the center view data C is sequentially inserted between series right view data R pairs and left view data L pairs (RRCLL).

When the viewing distance is equivalent to or greater than the far distance threshold, five different data sets of 3D far distance mode (CLLRR, LLRRC, LRRCL, RRCLL, RCLLR) are provided. According to changes of the viewing angle, one of the five data sets of 3D far distance mode (CLLRR, LLRRC, LRRCL, RRCLL, RCLLR) is selected and displayed by the pixel layer.

It is noted that the ranges of switching data set of the data table according to the viewing distance D and/or the viewing angle θaxis are not limited. That is, the far distance threshold may be not fixed but can be adjusted according to types of the input videos. For instance, the far distance threshold corresponding to an action movie may be shorter than that corresponding to a still image.

Furthermore, boundaries between the viewing angles corresponding to different two data sets may vary. For instance, in the 3D near distance mode, the boundary corresponding to the second data set of 3D near distance mode CRRLL and the third data set of 3D near distance mode RRLLC is assumed to be x=0, but some offset of the boundary can be tolerated.

Furthermore, the display device may provide hysteresis function while adjusting data set of the pixel layer. Assuming that the viewing position was originally in the 3D near distance mode, the display panel will not change to the 3D far distance mode immediately when the viewing distance is equivalent to or slightly greater than the far distance threshold. Instead, the display device may gradually change data set of the pixel layer. Therefore, the viewer will not see dramatic change of the 3D images when the viewing distance is changed from the 3D far distance mode to the 3D near distance mode. Similarly, the viewer will not see dramatic change of the 3D images when the viewing distance is changed from the 3D near distance mode to the 3D far distance mode.

It is noted that, number of sub-pixels used as a unit of data set may vary. For instance, another embodiment shown below uses six sub-pixels as the unit of data set. Details about the allocations of the pixel layer and the optical modulating layer 41 and the selection of data sets are not redundantly described herein.

FIG. 15 is a schematic diagram illustrating a data table with various data sets, wherein each of the data sets constitutes six sub-pixels. In FIG. 15, four types of display modes are provided, i.e. 2D display mode, 3D near distance mode, 3D intermediate distance mode, and 3D far distance mode.

When the viewing distance is very short, the crosstalk between the left view data L and the right view data R is serous so that 3D images cannot be properly displayed. Therefore, when the viewing distance is less than a near distance threshold, the display device displays 2D images as shown in FIG. 15.

When the viewing distance is equivalent to or greater than the near distance threshold, the display device display 3D images. The 3D mode in FIG. 15 is further classified as a 3D near distance mode, a 3D intermediate distance mode, and a 3D far distance mode.

When the viewing distance is between the near distance threshold and an intermediate distance threshold, six different data sets of 3D near distance mode (LLCCRR, LCCRRL, CCRRLL, CRRLLC, RRLLCC, RLLCCR) are provided. According to changes of the viewing angle, one of the six data sets of 3D near distance mode (LLCCRR, LCCRRL, CCRRLL, CRRLLC, RRLLCC, RLLCCR) is selected and displayed by the pixel layer.

When the viewing distance is between the intermediate distance threshold and a far distance threshold, six different data sets of 3D intermediate distance mode (LLCRRC, LCRRCL, CRRCLL, RRCLLC, RCLLCR, CLLCRR) are provided. According to changes of the viewing angle, one of the six data sets of 3D intermediate distance mode (LLCRRC, LCRRCL, CRRCLL, RRCLLC, RCLLCR, CLLCRR) is selected and displayed by the pixel layer.

When the viewing distance is equivalent to or greater than the far distance threshold, six different data sets of 3D far distance mode (CLLRRC, LLRRCC, LRRCCL, RRCCLL, RCCLLR, CCLLRR) are provided. According to changes of the viewing angle, one of the six data sets of 3D far distance mode (CLLRRC, LLRRCC, LRRCCL, RRCCLL, RCCLLR, CCLLRR) is selected and displayed by the pixel layer.

An example about change of the viewing position and control of the display device is illustrated. Firstly, it is assumed that the viewing position changes from the first position P1 to the second position P2. In such case, the viewing distance D changes but the viewing angle θaxis remains the same.

When the viewing position is at the first position P1, the display device displays in 2D mode. When the viewing distance D becomes greater than the near distance threshold, the display device changes to display with data set RRLLCC. Then, when the viewing distance D becomes greater than the intermediate distance threshold, the display device changes to display with data set RRCLLC. Afterwards, when the viewing distance D becomes greater than the far distance threshold, the display device changes to display with data set RCCLLR. Thus, when the viewing position is at the second position P2, the display device displays with data set RCCLLR.

Secondly, it is assumed that the viewing position changes from the third position P3 to the fourth position P4. In such case, the viewing angle θaxis changes but the viewing distance D remains the same. When the viewing position is at the third position P3, the display device displays data set RRCCLL. Then, the display device changes to display with data set LRRCCL, LLRRCC, and CLLRRC respectively when the viewing position gradually changes. When the viewing position is at the fourth position P4, the display device displays with data set CLLRRC.

Classification and types of the viewing distance and the viewing angle, as well as types and constitutions of data sets may vary with practical application. Details about how to adjust control flow regarding these variations are known in the art, and are not redundantly described herein.

In the above embodiments, the center view data C is assumed to be generated by referring to the left view data L, the right view data R and depth map. Another approach of generating 3D image is to capture the center view data C in advance, together with the left view data L and the right view data. Such approach is called the multi-view technology.

FIG. 16 is a schematic view illustrating formulation of 3D image based on multi-view technology. The camera 51 captures images from left side of the object 51, in front of the object 51 and from right side of the object 51 in order to respectively generate the left view data L, the center view data C and the right view data R. The multi-view technology requires more memory space for storing center view data C.

The above embodiment considers only one center view data, but more center view data may be used. FIG. 22 is a schematic view illustrating more data sets are provided according to another embodiment of the present invention. According to FIG. 22, more types of center view data are used, that is, a left-center view data CI, a central-center view data Cc and/or a right-center view data Cr. In such case, the display device can provide smoother switching of data sets.

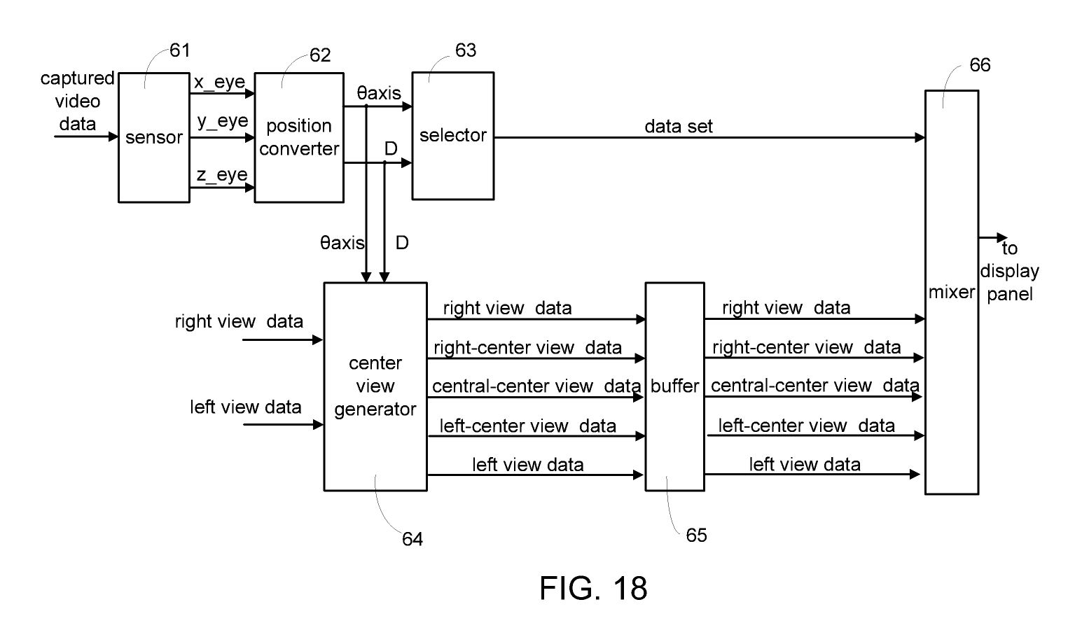

FIG. 17 is a schematic functional block diagram illustrating a 3D view control unit of an embodiment with multiple center view data. An upper transmission path and a lower transmission path are shown in FIG. 18. The upper transmission path indicates selection of the data set, and the lower transmission path indicates generation of the center view data.

As shown in FIG. 18, the 3D view control unit includes a sensor 61, a position converter 62, a selector 63, a center view generator 64, a buffer 65, and a mixer 66. After receiving captured video data, the sensor 61 senses the viewing position (x_eye, y_eye, z_eye) and transmits the viewing position to the position converter 62. Then, the position converter 62 calculates and obtains the viewing distance D and the viewing angle θaxis. According to the viewing distance D and the viewing angle θaxis, the selector 63 may select one of the data sets of the pixel layer corresponding to the viewing position. The selection of which data set should be adopted is further transmitted to the mixer 66.

The center view generator 64 receives the viewing distance D, the viewing angle θaxis, the right view data R and the left view data L and accordingly generates the left-center view data Cl, the central-center view data Cc, and the right-center view data Cr. The right view data R, the left-center view data CI, the central-center view data Cc the right-center view data Cr and the left view data L are temporarily stored in the buffer 65 and further provided to the mixer 66. Moreover, the mixer 66 mixes the right view data R, the left-center view data CI, the central-center view data Cc the right-center view data Cr and the left view data L according to the output of the selector 63. The mixture result outputted from the mixer 66 becomes the data set to be displayed by the display panel.

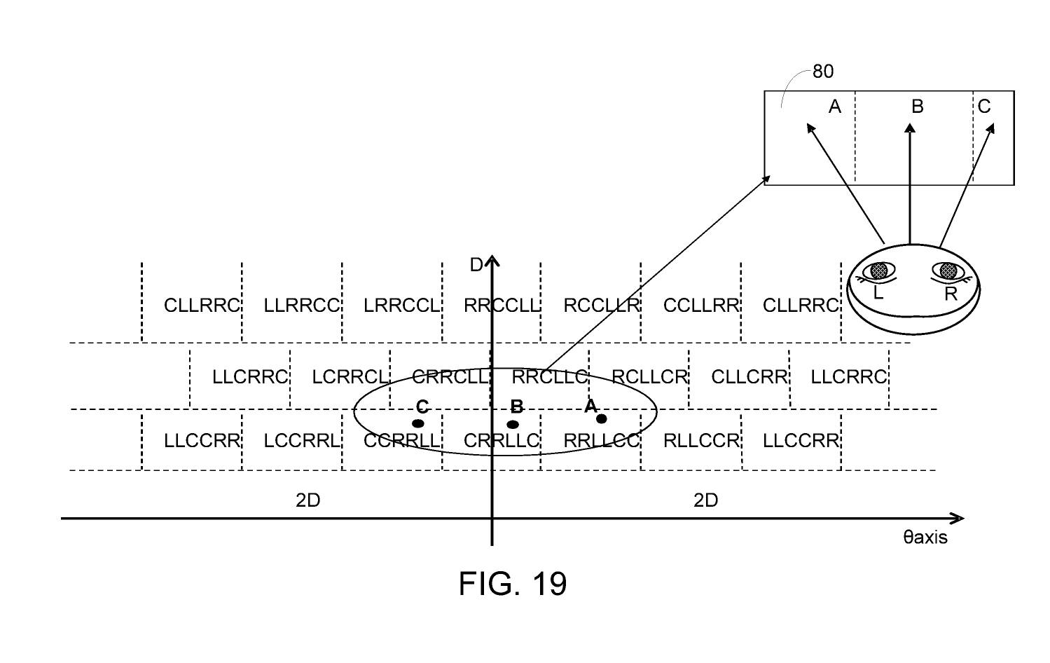

FIG. 19 is a schematic diagram illustrating the application of the present invention to a display device with large screen size. According to the present invention, the display device with large screen size may be divided into several regions and each region display with a corresponding data set of the data table.

According to the viewing position, it is assumed that after the viewing position is sensed and the viewing distance and the viewing angle are obtained, the data set CRRLLC is selected. Instead of displaying with CRRLLC for the whole display device 80, the display device 80 is divided into three regions and only the center region of the display device 80 (i.e. the region B) displays with data set CRRLLC. The left region (i.e. the region A) of the display device displays with data set RRLLCC, and the right region (i.e. the region C) of the display device displays with data set CCRRLL. Where the viewing angle is a tilt angle from each region to eyes, not the display center to the eyes that described in FIG. 11B.

According to the concept of the present invention, data set displayed by the pixel layer is adjusted. The materials or techniques used as an optical modulating layer of the optical modulating display are not limited. The optical modulating layer is only an exemplary of the present invention. Therefore, a lenticular lens array, a gradient-index (hereinafter, GRIN) optical lens array, or a barrier array may also be adopted as the optical modulating layer according to the present invention.

According to the above illustrations, the 3D display device flexibly adjusts data set of the pixel layer according to practical viewing position. The control method considers not only changes of viewing distance and viewing angle. In addition, hysteresis function, number of sub-pixels used for the data set, large screen size may also be referred while adjusting data set of the pixel layer. Thus, the control method according to the present invention guarantees the display panel to display 3D images with good quality.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display device, comprising:
a sensing unit for obtaining a distance mode and a viewing angle according to a viewing position;
a selector, for selecting a data set from a data table;
a center view generator, for generating a center view data according to a left view data and a right view data;
a mixer, for mixing the left view data, the right view data, and the center view data into an image according to the data set; and
a display panel, for displaying the image,
wherein the data set is adjusted according to the distance mode and the viewing angle.

2. The display device as claimed in claim 1, wherein the sensing unit comprising:
a sensor, for sensing viewing position parameters according to a captured video data; and
a position convertor, for obtaining the distance mode and the viewing angle according to the viewing position parameters.

3. The display device as claimed in claim 1, wherein the display device further comprises an optical modulating panel with an optical modulating layer, wherein the optical modulating panel is disposed on the display panel.

4. The display device as claimed in claim 3, wherein the optical modulating layer is a lenticular lens array, a gradient-index optical lens array, or a barrier array.

5. The display device as claimed in claim 1, wherein the center view data is intermediate parallax based on a depth of the left view data and right view data.

6. The display device as claimed in claim 1, wherein the display panel comprises a pixel layer with a plurality of sub-pixels.

7. The display device as claimed in claim 6, wherein each of the data set comprises five sub-pixels, and the data table comprises a 2D display mode, a 3D near distance mode, and a 3D far distance mode.

8. The display device as claimed in claim 7, in the 3D near distance mode, the center view data is sequentially inserted behind series of a right view data pair and a left view data pair.

9. The display device as claimed in claim 7, in the 3D far distance mode, the center view data is sequentially inserted between series of a right view data pair and a left view data pair.

10. The display device as claimed in claim 6, wherein each of the data set comprises six sub-pixels, and the data table comprises a 2D display mode, a 3D near distance mode, a 3D intermediate distance mode, and a 3D far distance mode.

11. The display device as claimed in claim 10, wherein in the 3D near distance mode, the center view data pairs is sequentially inserted behind series of the right view data pairs and the left view data pairs.

12. The display device as claimed in claim 10, wherein in the 3D far distance mode, the center view data pairs is sequentially inserted between series of the right view data pairs and the left view data pairs.

13. The display device as claimed in claim 10, wherein in the 3D intermediate distance mode, the center view data is sequentially inserted between the right view data pairs and the left view data pairs.

14. A controlling method of a display device, wherein the display device comprises a display panel, the controlling method comprising steps of:
sensing a viewing position and accordingly obtaining a viewing distance and a viewing angle;
judging a distance mode according to the viewing distance;
selecting a data set from a data table, wherein the data set is mixed with a left view data, a right view data and a center view data; and,
adjusting the data set according to the distance mode and the viewing angle.

15. The controlling method as claimed in claim 14, further comprising steps of:
receiving the left view data and the right view data; and
generating the data set of the pixel layer according to the left view data, the right view data and the center view data.

16. The controlling method as claimed in claim 14, wherein the center view data is intermediate parallax based on a depth of the left view data L and right view data R

17. The controlling method as claimed in claim 14, wherein each of the data set comprises five sub-pixels, and the data table comprises a 2D display mode, a 3D near distance mode, and a 3D far distance mode.

18. The controlling method as claimed in claim 14, wherein each of the data set comprises six sub-pixels, and the data table comprises a 2D display mode, a 3D near distance mode, a 3D intermediate distance mode, and a 3D far distance mode.
